(19) United States
(12) Patent Application Publication
(10) Pub. No.: US 2025/0154711 A1
(43) Pub. Date: May 15, 2025

(54) CLOTHES CARE APPARATUS

(71) Applicant: SAMSUNG ELECTRONICS CO., LTD., Suwon-si (KR)

(72) Inventors: Hyunjoo KIM, Suwon-si (KR); Kisup LEE, Suwon-si (KR); Sujin SEONG, Suwon-si (KR); Dongwoo SHIN, Suwon-si (KR); Kwonchul YUN, Suwon-si (KR); Donggi HAN, Suwon-si (KR)

(73) Assignee: SAMSUNG ELECTRONICS CO., LTD., Suwon-si (KR)

(21) Appl. No.: 19/022,807

(22) Filed: Jan. 15, 2025

Related U.S. Application Data
(63) Continuation of application No. PCT/KR2023/010010, filed on Jul. 13, 2023.

(30) Foreign Application Priority Data
Aug. 24, 2022 (KR) 10-2022-0106282

(51) Int. Cl. D06F 58/10; D06F 58/22

(52) U.S. Cl. CPC D06F 58/10; D06F 58/22

(57) ABSTRACT

A clothes care apparatus includes a main case including an upper fan, and a clothes care room, arranged within the main case, including a first airflow inlet and a second airflow inlet configured to respectively draw in air discharged from the upper fan. The clothes care apparatus includes a machine room, arranged at a lower portion of the clothes care room, including a third airflow inlet configured to respectively draw in the air discharged from the upper fan and an airflow outlet configured to discharge the air drawn in. The first airflow inlet is spaced apart from the second airflow inlet on an upper side, and the first airflow inlet, the second airflow inlet, and the airflow outlet are configured to allow air flow between the clothes care room and the main case through a communication duct arranged between the clothes care room and the main case.

### CROSS-REFERENCE TO RELATED APPLICATION

This application is a continuation application is a continuation application, under 35 U.S.C. § 111(a), of international application No PCT/KR2023/010010, filed Jul. 13, 2023, which claims priority under 35 U.S.C. § 119 to Korean Patent Application No. 10-2022-0106282, filed Aug. 24, 2022, the disclosures of which are incorporated herein by reference in their entireties.

### TECHNICAL FIELD

The disclosure relates to a clothes care apparatus, and more particularly, to a clothes care apparatus that uses airflow to manage clothes.

### BACKGROUND ART

A clothes care apparatus is a device that performs clothes care, such as drying wet clothes, removing dirt attached to clothes or odors from clothes, and reducing wrinkles in clothes.

A clothes care apparatus typically includes a clothes care room, which is a receiving space where clothes is stored, and a machine room located below, which includes a steam generating device or a hot air supplying device to perform refreshing functions, such as wrinkle removals, deodorization, static electricity removal, and the like. The clothes care room and the machine room may be separated by a partition.

The clothes care apparatus may have a clothes support member arranged in the clothes care room to hold clothes and caring the clothes by providing airflow to the clothes support member.

A blower device for providing such airflow is also provided in in the clothes care apparatus, and the airflow discharged from the blower device is supplied to the clothes support member in the clothes care room to perform clothes care.

In the machine room, a fan for blowing air toward the clothes care room is separately provided. Accordingly, clothes may be treated by blowing airflow including steam or air at a high temperature into the clothes care room generated by the steam generating device or the hot air supplying device installed in the machine room by the fan.

### DISCLOSURE

### Technical Problem

According to an embodiment, a clothes care apparatus capable of reducing noise is provided.

According to an embodiment, a clothes care apparatus capable of reducing noise generated by a fan is provided.

According to an embodiment, a clothes care apparatus is provided in which a fan is not installed in a machine room.

According to an embodiment, a clothes care apparatus is provided that effectively removes fine dust from clothes.

According to an embodiment, a clothes care apparatus capable of effectively puffing clothes is provided.

According to an embodiment, a clothes care apparatus is provided that may effectively blow air discharged into a clothes care room onto clothes.

According to an embodiment, a clothes care apparatus is provided that maintains the momentum of the flow discharged into a clothes care room.

According to an embodiment, a clothes care apparatus is provided that maintains the flow of air in a clothes care room.

According to an embodiment, a clothes care apparatus is provided that prevents the air inlet from drawing in all the air discharged into a clothes care room.

Technical tasks to be achieved in this document are not limited to the technical tasks mentioned above, and other technical tasks not mentioned will be clearly understood by those skilled in the art from the description below.

### Technical Solution

According to an embodiment of the present disclosure, a clothes care apparatus includes a main case including an upper fan, and a clothes care room arrangeable within the main case and including a first airflow inlet and a second airflow inlet configured to respectively draw in air discharged from the upper fan. The clothes care apparatus includes a machine room arrangeable at a lower portion of the clothes care room and including a third airflow inlet configured to respectively draw in the air discharged from the upper fan and an airflow outlet configured to discharge the air drawn in from the third airflow inlet. The first airflow inlet is arrangeable on an upper side of the second airflow inlet and to be spaced apart from the second airflow inlet. The first airflow inlet, the second airflow inlet, and the airflow outlet are configured to allow air flow between the clothes care room and the main case through a communication duct arrangeable between the clothes care room and the main case.

An area of the first airflow inlet may be configured to be greater than an area of the second airflow inlet to allow the amount of air drawn in from the first airflow inlet to be greater than the amount of air drawn in from the second airflow inlet.

The communication duct may include a communication flow path configured such that the air discharged from the airflow outlet flows together with the air drawn in from the first airflow inlet and the air drawn in through the second airflow inlet.

The communication duct may further include a plurality of airflow guides arrangeable on the communication flow path.

The communication duct may be configured to communicate with the upper fan.

The first airflow inlet, the second airflow inlet, and the third airflow inlet each may include a dust collector configured to filter out foreign matter in the drawn-in air.

The clothes care room may further include a fourth airflow inlet arrangeable between the first airflow inlet and the second airflow inlet so as to draw in the air discharged from the upper fan to the clothes care room.

An area of the fourth airflow inlet may be configured to be smaller than the area of the first airflow inlet and larger than the area of the second airflow inlet.

The fourth airflow inlet may be configured to allow air to flow to the communication duct.

The fourth airflow inlet may include a dust collector configured to filter out foreign matter in the drawn-in air.

According to an embodiment of the present disclosure, a clothes care apparatus includes a main body including a clothes care room enabled to receive clothes, an upper fan arrangeable on an upper portion of the clothes care room and configured to discharge air to an inside of the clothes care room, and a machine room arrangeable at a lower portion of the clothes care room and including a heat exchanger. The clothes care room includes a first airflow inlet and a second airflow inlet configured to respectively draw in airflow generated at the inside of the clothes care room. The area of the first airflow inlet is configured to be greater than the area of the second airflow inlet. The first airflow inlet and the second airflow inlet each include a dust collector configured to filter out foreign matter in the drawn-in air.

The first airflow inlet and the second airflow inlet may be arranged so that they are spaced apart from each other in a vertical direction on a surface of the clothes care room. The first airflow inlet may be arranged on an upper side of the second airflow inlet.

The machine room may include a third airflow inlet configured to draw in a portion of the airflow generated at the inside of the clothes care room and including a dust collector, and include an airflow outlet configured to discharge the air drawn in from the third airflow inlet.

The clothes care apparatus may further include a communication duct arranged between the clothes care room and the main body such that the first airflow inlet, the second airflow inlet, and the airflow outlet are configured to allow airflow between each other.

The communication duct may be configured to airflow from the upper fan.

The clothes care room may further include a fourth airflow inlet arranged between the first airflow inlet and the second airflow inlet so as to respectively draw in the air discharged from the upper fan to the clothes care room. The fourth airflow inlet may include a dust collector configured to filter out foreign matter in the air. The area of the fourth airflow inlet may be configured to be smaller than that of the first airflow inlet and larger than that of the second airflow inlet. The fourth airflow inlet may be configured to communicate with the communication duct.

### Advantageous Effects

According to various embodiments of the present disclosure, the clothes care apparatus may not include a separate fan in the machine room, thereby reducing noise from the fan.

According to various embodiments of the present disclosure, the clothes care apparatus may include the plurality of inlets for receiving air discharged into the clothes care room, thereby distributing the intake pressure.

According to various embodiments of the present disclosure, the clothes care apparatus may distribute the intake pressure to prevent all of the air discharged into the clothes care room from being drawn into a particular inlet.

According to various embodiments of the present disclosure, the clothes care apparatus may effectively puff up the clothes as the air discharged into the clothes care room hits the upper surface of the machine room, changes direction, and then maintains momentum to reach the clothes.

The effects to be obtained from the present disclosure are not limited to those mentioned above, and other effects not mentioned will be apparent to those of skilled in the art from the following description.

### DESCRIPTION OF DRAWINGS

FIG. 1 is a perspective view showing a clothes care apparatus according to an embodiment.

FIG. 2 is a view showing the clothes care apparatus with a door open, according to an embodiment.

FIG. 3 is an exploded perspective view showing the clothes care apparatus shown in FIG. 1, according to an embodiment.

FIG. 4 is a view showing an interior of a main case of the clothes care apparatus according to an embodiment.

FIG. 5 is a view showing air being discharged from an upper fan into a clothes care room, according to an embodiment.

FIG. 6 is a perspective view including a side cross-section of the clothes care apparatus according to an embodiment.

FIG. 7 is a cross-sectional view of the clothes care apparatus according to an embodiment, wherein a portion of the air discharged into the clothes care room is drawn into a second inlet and a third inlet, and the remaining air hits the floor and then changes direction to rise back toward hanger side.

FIG. 8 is a cross-sectional view of the clothes care apparatus according to an embodiment, wherein a portion of the air rising to the hanger side shown in FIG. 7 is drawn into a first airflow inlet, and the air drawn into second and third airflow inlets flows into a communication duct.

FIG. 9 is a cross-sectional view of the clothes care apparatus according to an embodiment, wherein the air remaining after being drawn in from the first airflow inlet shown in FIG. 8 rises to the hanger side, and the air drawn in from the first, second, and third airflow inlets is merged in the communication duct and flows into the communication duct.

FIG. 10 is a view showing the air flowing on a communication flow path, according to an embodiment.

FIG. 11 is a cross-sectional view of the clothes care apparatus including a fourth airflow inlet according to an embodiment.

### MODES OF THE INVENTION

Embodiments described in the disclosure and configurations shown in the drawings are merely examples of the embodiments of the disclosure and may be used in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

As used herein, the terms “front”, “rear”, “upper”, “lower”, “left”, “right”, and the like are defined with reference to the drawings and are not intended to limit the shape and location of each component.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

When referring to the direction of rotation, clockwise direction may be expressed as a first direction, and counterclockwise direction as a second direction. This expression may be used to describe the detailed contents of the disclosure, but it does not limit the direction of rotation of the elements of the present disclosure.

Hereinafter, various embodiments according to the disclosure will be described in detail with reference to the accompanying drawings.

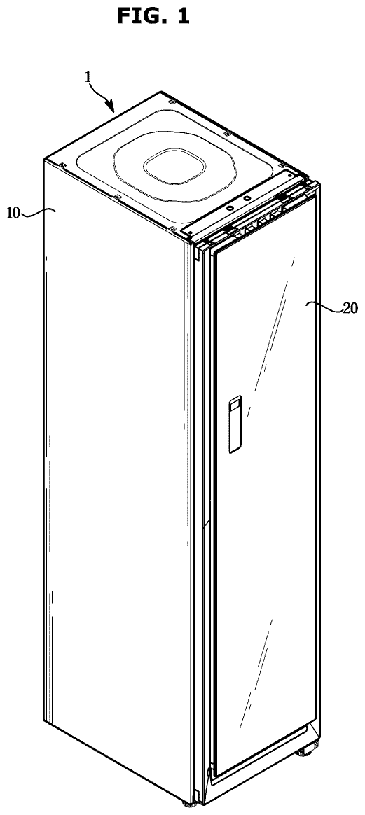

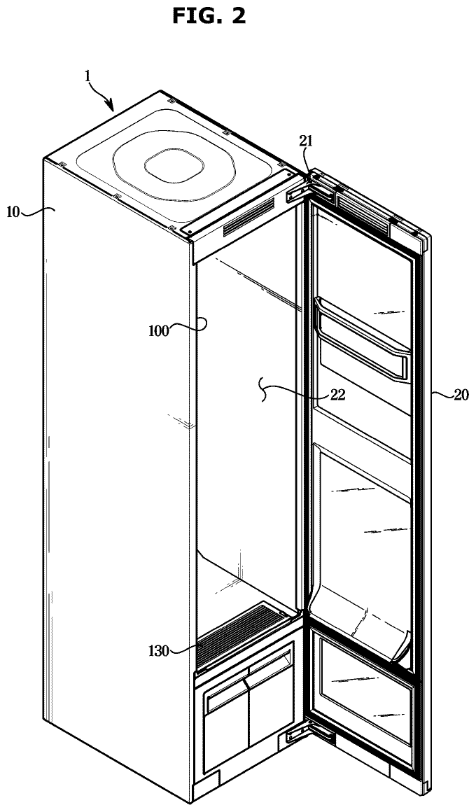

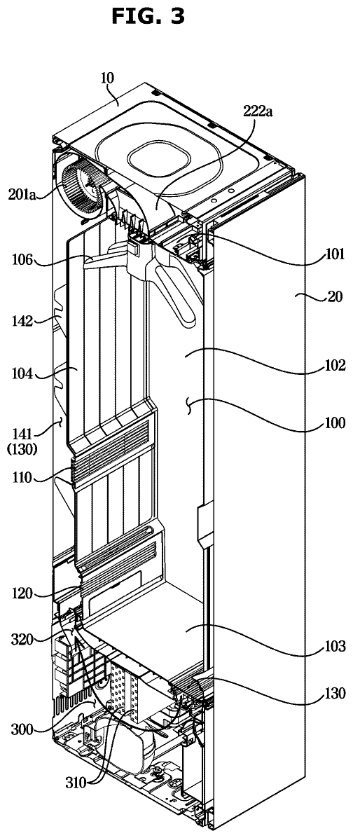

FIG. 1 is a perspective view showing a clothes care apparatus according to an embodiment. FIG. 2 is a view showing a state in which a door of the clothes care apparatus according to an embodiment is open. FIG. 3 is an exploded perspective view showing the clothes care apparatus shown in FIG. 1.

Referring to FIGS. 1 to 3, a clothes care apparatus may include a main case 10 forming an exterior thereof and a door 20 rotatably coupled to the main case 10.

A clothes care apparatus 1 may include a clothes care room 100 arranged within the main body to accommodate and care clothes, a hanger 106 arranged within the clothes care room 100 to hang the clothes, and a machine room 300 equipped with a heat exchanger 310 configured to dehumidify or heat the air inside the clothes care room 100.

The clothes care room 100 may be formed on an inside of the main case 10, and upper fans 201a and 201b configured to discharge air into the clothes care room 100 may be formed on an upper portion of the clothes care room 100. The upper fans 201a and 201b may be configured to form an intake force in a first airflow inlet 110, a second airflow inlet 120, and a third airflow inlet 130. The first airflow inlet 110, the second airflow inlet 120, and the third airflow inlet 130 will be described later.

The clothes care room 100 may have a substantially hexahedral shape with one side open. An opening 22 may be formed on a front side of the main case 10.

The door 20 that is rotatably coupled to open or close the clothes care room 100 may be mounted to the main case 10. The door 20 may be installed on the main case 10 by a hinge 21 or the like.

The clothes care room 100 may form a space in which clothes is accommodated. The clothes care room 100 may be provided within the main case 10 and may include an upper surface 101, a lower surface 103, a left surface 105, a right surface 102, and a rear surface 104.

The front surface of the clothes care room 100 may be formed by the opening 22. Accordingly, the opening 22 of the clothes care room 100 may also be opened or closed by the door 20 that opens or closes the opening 22 of the main case 10.

The hanger 106 may be shaped like a hanger to allow clothes to be hung, but the shape of the hanger 106 is not limited to a hanger shape.

The hanger 106 may be designed to allow air to flow therethrough, such that dust and foreign matter on the clothes may be removed by the air supplied to the inside of the hanger 106. A detailed description of the structure of the hanger 106 will be described later.

The clothes care room 100 may include the first airflow inlet 110 and the second airflow inlet 120 that draw in a portion of the air discharged from the upper fans 201a and 201b. The first airflow inlet 110 and the second airflow inlet 120 may be arranged on the rear surface 104 of the clothes care room 100.

The first airflow inlet 110 may be arranged on an upper side of the second airflow inlet 120 and spaced apart from the second airflow inlet 120. The area of the first airflow inlet 110 may be configured to be larger than the area of the second airflow inlet 120 such that the amount of air drawn in through the first airflow inlet 110 is greater than the amount of air drawn in through the second airflow inlet 120.

The rear surface 104 of the clothes care room 100 in which the second airflow inlet 120 is installed may be configured to protrude further toward the opening 22 than the rear surface 104 of the clothes care room 100 in which the first airflow inlet 110 is installed.

The first airflow inlet 110 and the second airflow inlet 120 may each include a dust collector (not shown) that filters out foreign matter in the air being drawn in.

The machine room 300 may be arranged on a lower side of the main body. The machine room 300 may be arranged on a lower side of the clothes care room 100.

The heat exchanger 310 may be provided within the machine room 300. The heat exchanger 310 may be configured to dehumidify and heat the air inside the clothes care room 100 as needed. The heat exchanger 310 may be installed to supply hot air to the inside of the clothes care room 100.

The third airflow inlet 130 may be formed on an upper surface of the machine room 300 to draw in a portion of the air discharged from the upper fans 201a and 201b to the clothes care room 100. The third airflow inlet 130 may include a dust collector (not shown) that filters out foreign matter in the air being drawn in. The air drawn in through the third airflow inlet 130 may be dehumidified and heated by the heat exchanger 310.

The machine room 300 may include an air outlet 320. The air outlet 320 may be configured such that the air drawn in through the third airflow inlet 130 may be dehumidified and heated by the heat exchanger 310 and then discharged.

The machine room 300 may not be provided with a separate fan to provide the power to discharge the airflow. This may reduce the noise caused by the fan installed in the machine room 300.

The first airflow inlet 110, the second airflow inlet 120, and the air outlet 320 may be connected via a communication duct 140. The communication duct 140 may be disposed between the clothes care room 100 and the main case 10. In other words, the communication duct 140 may be formed by the rear surface 104 of the clothes care room 100 and the main case 10.

The air outlet 320 may be formed on the rear surface 104 of the clothes care room 100.

The communication duct 140 may include a communication flow path 140 configured such that air discharged from the air outlet 320 is merged and flows together with air drawn in from the first airflow inlet 110 and air drawn in from the second airflow inlet 120.

The communication duct 140 may be configured to communicate with the upper fans 201a and 201b. Accordingly, the air drawn in from the first airflow inlet 110, the air drawn in from the second airflow inlet 120, and the air discharged from the air outlet 320 may be joined and flow to the upper fans 201a and 201b.

The communication duct 140 may further include a plurality of airflow guides 142 provided on the communication flow path 140. The air drawn in from the first airflow inlet 110, the air drawn in from the second airflow inlet 120, and the air discharged from the air outlet 320 may be guided through the third airflow inlet 130 (path 141) and guided by the plurality of airflow guides 142 and flow along the communication flow path 140.

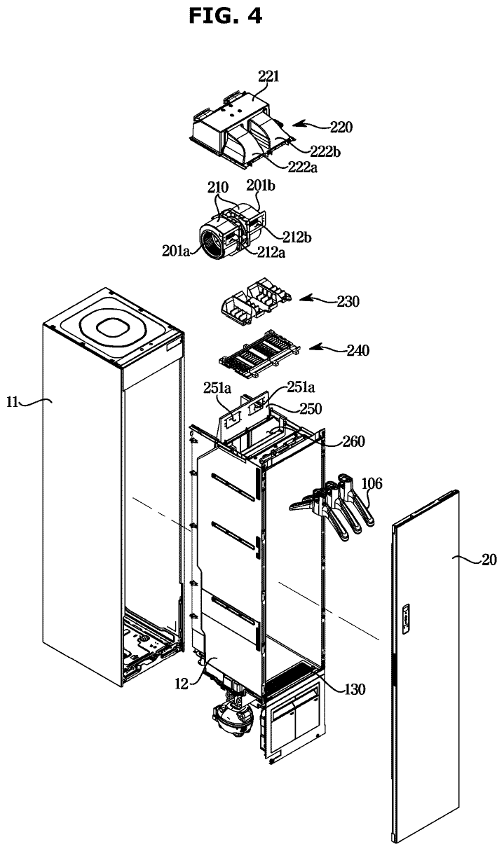

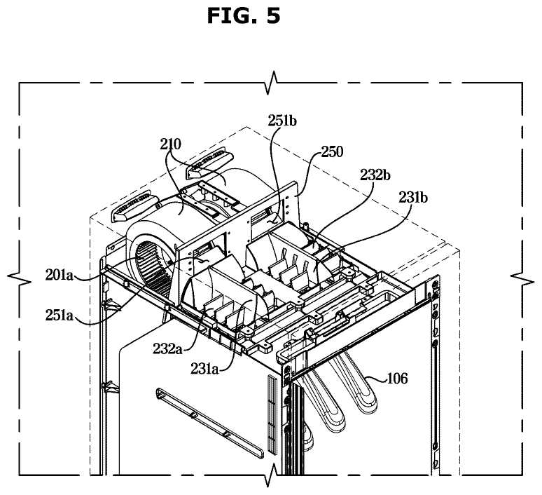

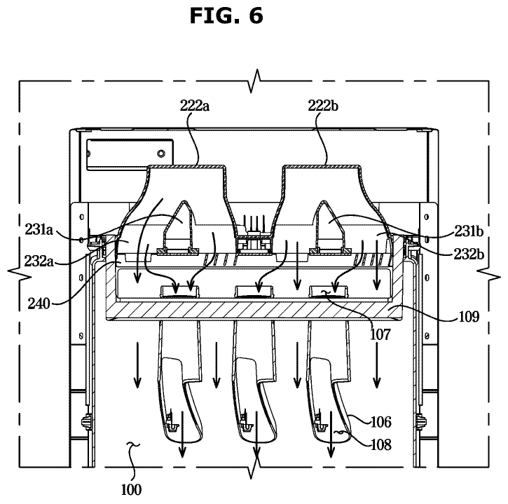

FIG. 4 is a view showing the inside of the main case of the clothes care apparatus according to an embodiment. FIG. 5 is a view showing air being discharged from the upper fan to the clothes care room, according to an embodiment. FIG. 6 is a perspective view including a side cross-section of the clothes care apparatus according to an embodiment.

Referring to FIGS. 4 to 6, the main case 10 may include a first main case 11 forming an exterior thereof. The main case 10 may include a second main case 12 provided within the first main case 11 to form the clothes care room 100.

The air drawn in from the first airflow inlet 110, the air drawn in from the second airflow inlet 120, and the air discharged from the air outlet 320 may be joined and flow along the communication duct 140.

The air flowing on the communication flow path 140 of the communication duct 140 may flow into the upper fan 20. Accordingly, the intake force generated at the first airflow inlet 110 and the second airflow inlet 120 and the power that cause the airflow to be discharged from the airflow outlet 320 may be provided by the operation of the upper fans 201a and 201b. The power to flow the air on the communication flow path 140 may be provided by the driving of the upper fans 201a and 201b.

The upper fans 201a and 201b may be arranged at a point that is an inside of the first main case 11 and an upper portion of the second main case 12.

The upper fans 201a and 201b may include a first upper fan 201a and a second upper fan 201b that discharge air. The first upper fan 201a and the second upper fan 201b may be configured to receive and discharge air flowing from the communication duct 140.

The first upper fan 201a and the second upper fan 201b may each include a fan housing 210. The first upper fan 201a and the second upper fan 201b may be covered by the fan housing 210, thereby preventing the first upper fan 201a and the second upper fan 201b from contacting other configurations due to vibrations caused by driving the first upper fan 201a and the second upper fan 201b.

A motor 211 may be provided in the center of the fan housing 210. The motor 211 may be connected to the first upper fan 201a and the second upper fan 201b to drive the first upper fan 201a and the second upper fan 201b.

The fan housing 210 may include a first fan housing opening 212a and a second fan housing opening 212b provided on a side facing the door 20. The airflow discharged by the driving of the first upper fan 201a and the second upper fan 201b may be arranged to pass through the first fan housing opening 212a and the second fan housing opening 212b.

The second main case 12 may include a partition 250 protruding in a direction intersecting with a flow direction of the air discharged from the first upper fan 201a and the second upper fan 201b. The partition 250 may include a first nozzle 251a and a second nozzle 251b.

The first nozzle 251a and the second nozzle 251b may be formed to correspond to the first fan housing opening 212a and the second fan housing opening 212b, respectively. Accordingly, the airflow discharged from the first upper fan 201a may flow through the first fan housing opening 212a and pass through the first nozzle 251a. The airflow discharged from the second upper fan 201b may flow through the second fan housing opening 212b and pass through the second nozzle 251b.

The fan housing 210 may be configured to be covered by a circulation duct 220. The circulation duct 220 may include a cover portion 221 that accommodates the fan housing 210. The cover portion 221 may have a shape of an approximately cuboid, but the shape of the cover portion 221 is not limited thereto, and may be any shape that may cover the fan housing 210.

The circulation duct 220 may include a first airflow guide portion 222a and a second airflow guide portion 222b provided on a front side of the cover portion 221. The first airflow guide portion 222a may be arranged on a front side of the first upper fan 201a so as to correspond to the first upper fan 201a. The second airflow guide portion 222b may be arranged on a front side of the second upper fan 201b so as to correspond to the second upper fan 201b.

The first airflow guide portion 222a and the second airflow guide portion 222b may include a curved surface (231a, 231b, 232a, 232b) that guides the airflow discharged from the first upper fan 201a and the second upper fan 201b, respectively. The respective curved surfaces included in the first airflow guide portion 222a and the second airflow guide portion 222b may change the flow direction of the airflow discharged from the first upper fan 201a and the second upper fan 201b to the door 20 toward the clothes care room 100.

An airflow outlet 260 may be arranged on an upper portion of the second main case 12 to allow the airflow flowing to the clothes care room 100 side to be introduced into the clothes care room 100.

The airflow outlet 260 may be provided with an outlet guide 230 that guides the air discharged from the first upper fan 201a and the second upper fan 201b into the clothes care room 100.

The outlet guide 230 may include a first dividing section and a second dividing section. The first and second dividing sections may be configured to cover a portion of the airflow outlet 260 so that the wind blown by the first upper fan 201a and the second upper fan 201b may not enter the clothes care room 100.

The outlet guide 230 may include a first outlet guide 230 and a second outlet guide 230. The first and second outlet guides 230 may be configured to allow the wind blown by the first upper fan 201a and the second upper fan 201b to enter the clothes care room 100.

A connection duct 240 may be provided in the airflow outlet 260. The connection duct 240 may be arranged on a lower portion of the outlet guide 230. The connection duct 240 may be configured to allow the air flowing through the first outlet guide 230 and the second outlet guide 230 of the outlet guide 230 to enter the clothes care room 100 side.

A hanger rack 109 may be provided at a point that is the inside of the clothes care room 100 and lower than the connection duct 240. The hanger rack 109 may be detachably provided with hangers 106.

Although three hangers 106 are detachably provided on the hanger rack 109 in the drawings, the number of hangers 106 is not limited thereto, and more than three may be provided within a range that does not interfere with the management of clothes.

Each of the hangers 106 may include a first hanger opening 107 provided on a side that contacts the hanger rack 109. The hanger 106 may be provided in a hollow form. The hanger 106 may include a second hanger opening 108 provided on a side facing the lower surface 103 of the clothes care room 100.

A portion of the air drawn into the clothes care room 100 through the connection duct 240 may be configured to be drawn in an inside of the hanger 106 through the first hanger opening 107. The air drawn in through the first hanger opening 107 may be discharged into the clothes care room 100 through the second hanger opening 108. This may allow the clothes hung on the hanger 106 to be puffed.

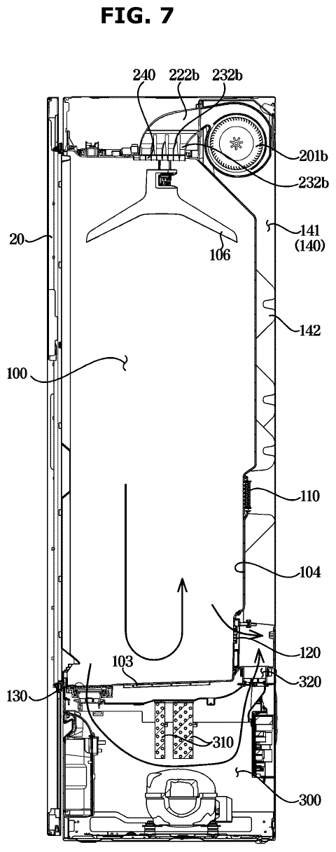

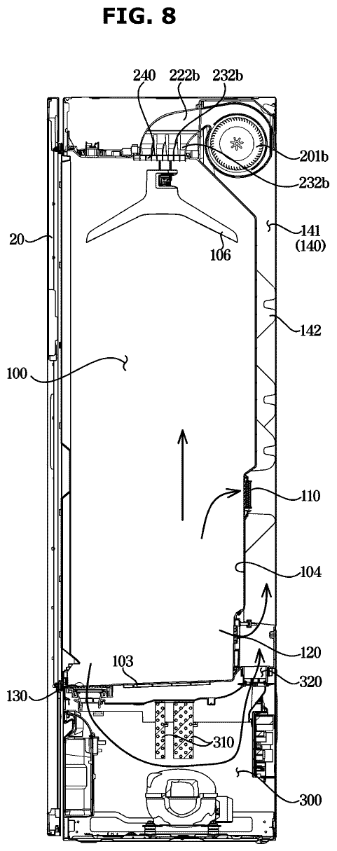

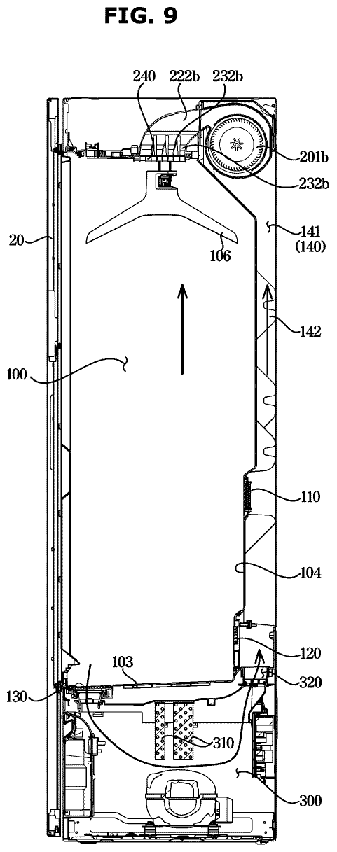

FIG. 7 is a cross-sectional view showing a portion of the air discharged into the clothes care room in the clothes care apparatus according to an embodiment being drawn into the second airflow inlet and the third inlet, and the remaining air changing direction after hitting the floor and rising back toward the hanger side. FIG. 8 is a cross-sectional view showing a portion of the air rising toward the hanger side shown in FIG. 7 being drawn into the first airflow inlet, and the air drawn into the second airflow inlet and the third inlet flowing into the communication duct. FIG. 9 is a cross-sectional view showing the air remaining after being drawn in from the first airflow inlet shown in FIG. 8 rising to the hanger side, and the air drawn in from the first, second, and third airflow inlets being merged in the communication duct and flows into the communication duct.

With reference to FIGS. 7 to 9, the flow of air inside the clothes care room 100 will be discussed in detail. Referring to FIGS. 7 to 9, the first airflow inlet 110, the second airflow inlet 120, and the third airflow inlet 130 may be arranged in the clothes care room 100. The intake force generated at each inlet may be generated by the power of the upper fans.

The intake force generated by the power of the upper fans 201a and 201b may be configured to be distributed to the first airflow inlet 110, the second airflow inlet 120, and the third airflow inlet 130, thereby preventing all of the momentum of the airflow being lost due to excessively high intake pressure of a single inlet. This may allow a portion of the airflow discharged toward the clothes care room 100 to continue flowing inside the clothes care room 100, resulting in the clothing becoming even more inflated.

A portion of the air discharged toward the clothes care room 100 may collide with the lower surface 103 of the clothes care room 100.

The air that collides with the lower surface 103 of the clothes care room 100 may change direction and flow toward the hanger 106.

A portion of the air flowing toward the hanger 106 may be drawn in by the first airflow inlet 110 before coming into contact with clothes. The air drawn in by the first airflow inlet 110 may be drawn into the communication duct 140 and flow to the upper fans 201a and 201b.

Of the air flowing toward the hanger 106, the air that is not drawn in by the first airflow inlet 110 may collide with the clothes and cause the clothes to puff up further. As the clothes become more inflated, it becomes easier to remove fine dust on the clothes.

A portion of the air discharged toward the clothes care room 100 may be drawn in by the second airflow inlet 120. The air drawn in by the second airflow inlet 120 may be drawn into the communication duct 140. The air drawn into the communication duct 140 may flow to the upper fans 201a and 201b through the communication flow path 140.

A portion of the air discharged toward the clothes care room 100 may be drawn in by the third airflow inlet 130. The air drawn in through the third airflow inlet 130 may be heated and its humidity reduced by passing through the heat exchanger 310. The air drawn in through the third airflow inlet 130 may be discharged through the air outlet 320. The air outlet 320 may be arranged to communicate with the communication duct 140. Accordingly, the air discharged through the air outlet 320 may be drawn into the communication duct 140 and flow to the upper fans 201a and 201b.

As described above, the air drawn in through the first airflow inlet 110, the second airflow inlet 120, and the third airflow inlet 130 may be combined in the communication duct 140 and flow together in the communication flow path 140.

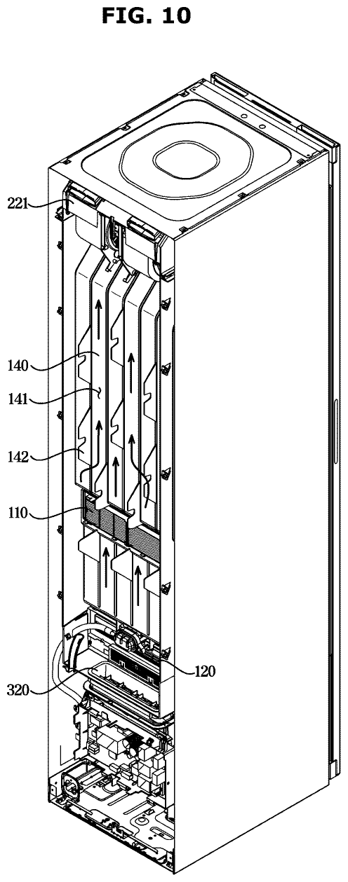

FIG. 10 is a view showing the air flowing on the communication flow path 140 according to an embodiment.

Referring to FIG. 10, the air drawn in from the first airflow inlet 110 and the second airflow inlet 120 and the air discharged from the air outlet 320 may be combined and flow in the communication duct 140. The air combined in the communication duct 140 may flow toward the upper fan through the communication flow path 140.

The air combined in the communication duct 140 may be guided and flowed through the plurality of airflow guides 142 arranged on the communication flow path 140.

The air combined in the communication duct 140 may be uniformly distributed and flowed through the plurality of airflow guides 142. Accordingly, the air may be uniformly distributed and drawn to the upper fans 201a and 201b.

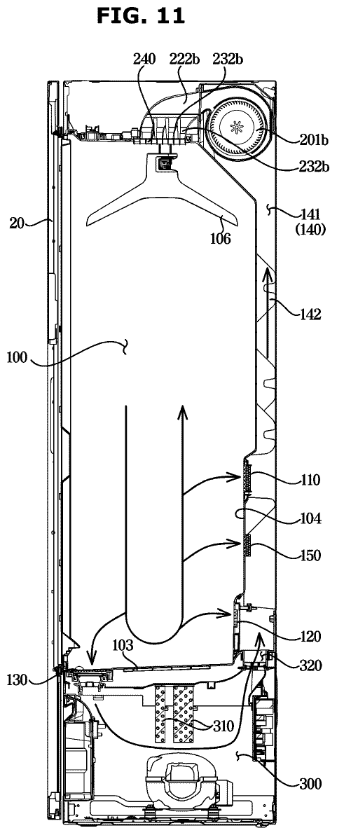

FIG. 11 is a cross-sectional view of the clothes care apparatus including a fourth inlet, according to an embodiment. The redundant description with the above description will be omitted below.

Referring to FIG. 11, the clothes care room 100 may further include a fourth airflow inlet 150 arranged between the first airflow inlet 110 and the second airflow inlet 120 so as to draw in a portion of the air discharged from the upper fan to the clothes care room 100.

The area of the fourth air inlet 150 may be configured to be smaller than that of the first airflow inlet 110 and larger than that of the second airflow inlet 120. Accordingly, the amount of air drawn in through the fourth air inlet 150 may be less than through the first airflow inlet 110 and more than through the second airflow inlet 120.

The fourth air inlet 150 may include a dust collector (not shown) that filters out foreign matter in the drawn-in air.

The fourth air inlet 150 may be configured to communicate with the communication duct 140. Accordingly, the air drawn in from the first airflow inlet 110, the second airflow inlet 120, the third airflow inlet 130, and the fourth air inlet 150 may be combined in the communication duct 140 and flow together to the upper fans 201a and 201b within the communication flow path 140.

While the present disclosure has been particularly described with reference to exemplary embodiments, it should be understood by those of skilled in the art that various changes in form and details may be made without departing from the spirit and scope of the present disclosure.

1. A clothes care apparatus comprising:
a main case including an upper fan;
a clothes care room, arrangeable within the main case, including a first airflow inlet and a second airflow inlet configured to respectively draw in air discharged from the upper fan; and
a machine room, arrangeable at a lower portion of the clothes care room, including a third airflow inlet configured to respectively draw in the air discharged from the upper fan and an airflow outlet configured to discharge the air drawn in through the third airflow inlet;
wherein the first airflow inlet is arrangeable on an upper side of the second airflow inlet and to be spaced apart from the second airflow inlet, and
the first airflow inlet, the second airflow inlet, and the airflow outlet are configured to allow air flow between the clothes care room and the main case through a communication duct arrangeable between the clothes care room and the main case.

2. The clothes care apparatus of claim 1, wherein an area of the first airflow inlet is configured to be greater than an area of the second airflow inlet to allow air drawn in through the first airflow inlet to be greater than air drawn in through the second airflow inlet.

3. The clothes care apparatus of claim 2, wherein the communication duct comprises a communication flow path configured such that the air discharged from the airflow outlet flows together with the air drawn in through the first airflow inlet and the air drawn in through the second airflow inlet.

4. The clothes care apparatus of claim 3, wherein the communication duct further comprises a plurality of airflow guides arrangeable on the communication flow path.

5. The clothes care apparatus of claim 4, wherein the communication duct is configured such that air flows between the upper fan and the communication duct.

6. The clothes care apparatus of claim 1, wherein the first airflow inlet, the second airflow inlet, and the third airflow inlet each include a dust collector configured to filter out foreign matter from the air that the first airflow inlet, the second airflow inlet, and the third airflow inlet respectively draw in.

7. The clothes care apparatus of claim 2, wherein the clothes care room further comprises a fourth airflow inlet arrangeable between the first airflow inlet and the second airflow inlet so as to respectively draw in the air discharged from the upper fan to the clothes care room.

8. The clothes care apparatus of claim 7, wherein an area of the fourth airflow inlet is configured to be smaller than the area of the first airflow inlet and larger than the area of the second airflow inlet.

9. The clothes care apparatus of claim 8, wherein the fourth airflow inlet is configured such that air flows between the fourth airflow inlet and the communication duct.

10. The clothes care apparatus of claim 7, wherein the fourth airflow inlet comprises a dust collector configured to filter out foreign matter in the air.
